(19) United States
(12) Patent Application Publication
(10) Pub. No.: US 2011/0032078 A1
(43) Pub. Date: Feb. 10, 2011

(54) Mobile CAT

(75) Inventors: Paul Francis Guziel, Roswell, GA (US); David Jason Schorr, Cumming, GA (US)

Correspondence Address: Baker Donelson;Intellectual Property Department, Monarch Plaza, Suite 1600, 3414 Peachtree Rd., ATLANTA, GA, 30326, US

(73) Assignee: Paul Francis Guiziel, Alpharetta, GA (US)

(21) Appl. No.: 12/535,935

(22) Filed: Aug. 5, 2009

(51) Int. Cl. G05B 19/00; G06K 5/00

(52) U.S. Cl. 340/5.86; 235/375

(57) ABSTRACT

Mobile device software application that uses the camera in a web-enabled PDA, cellular phone or smart phone to capture a barcode image off a lottery ticket, convert it to its unique serial number, pass it via cellular data service through a database query to generate a result set of win/loss data that can be returned to the PDA device.

### TECHNICAL FIELD AND INDUSTRIAL APPLICABILITY OF THE INVENTION

The use of a camera-enabled cellular phone or PDA to capture the image of a Code 128 barcode off the back of a lottery ticket, convert it to a number, then web connect to a server to check if the ticket is a winner.

### BACKGROUND OF THE INVENTION

We initiated discussions of developing a computer peripheral device to allow players to check a lottery ticket were at the Illinois Lottery in 2002. The original discussions revolved around a dead USB device called CueCat. It was a barcode scanner in the shape of a cat that was originally designed to drive consumers from print ads to WebPages for those advertisers. The product failed in that application, but could have been retooled to work as a lottery ticket reader with some new software applications. The ‘cat’ shape was perfect as CAT is an acronym in the lottery industry for Check A Ticket.

After 7 years of technological advances, there is no longer a need for a peripheral device to allow users to scan their lottery tickets to determine if it is a winner. Almost every cell phone and PDA in use today is equipped with a camera and enabled with Internet access and java technology. With the combination of those three elements, an average consumer can turn their existing cell phone into a Check A Ticket barcode reader with a simple J2ME or other mobile platform software application.

Terminal generated lottery games are the drawing/numbers games like Powerball, Mega Millions, Pick 3, Pick 4, Pick 5, Pick 6, Lotto games. Players pick a sequence of numbers and after a drawing, if all or some of the numbers match, the player wins a prize. Terminal generated lottery tickets are printed with a Code 128 or other standard format barcode to identify the date purchased, location and the numbers selected. If there are any winning numbers, the retailer scans the barcode to verify that it is a winning ticket.

Oftentimes, players don't realize that they are holding a winning ticket because they missed the drawing, didn't check their numbers or didn't realize they could win by matching fewer than all 6 numbers. A player could return any ticket to the retailer to have it scanned and determine if it is a winner. There is an inconvenience in having to return to the retail location just to check a ticket for winning combinations. Also, if they go to a dishonest retailer, the clerk could tell the player that it isn't a winning ticket, palm the ticket and then cash it after the player leaves the store.

The Mobile CAT software application would allow the user to check the ticket from any location and determine a win or loss.

### BRIEF SUMMARY OF THE INVENTION

A mobile device application that can capture a barcode image off a lottery ticket using the built-in camera on the mobile device (smart phone/cell phone/PDA); convert that barcode into a recognizable number; using the mobile device data connection submit that number in a SQL string to a winning ticket database; call the results from that database to return (GET) a resultset of ticket data (win/loss/pending draw); and display that data back on the mobile device.

### BRIEF DESCRIPTION OF THE DRAWINGS

FIG. 1—Camera Phone Barcode Reader: The built in camera on the consumer mobile device (phone) can be used to image the barcode off a lottery ticket. Once the image is captured, the software application interprets the barcode from the captured image and converts it to the unique code of the ticket.

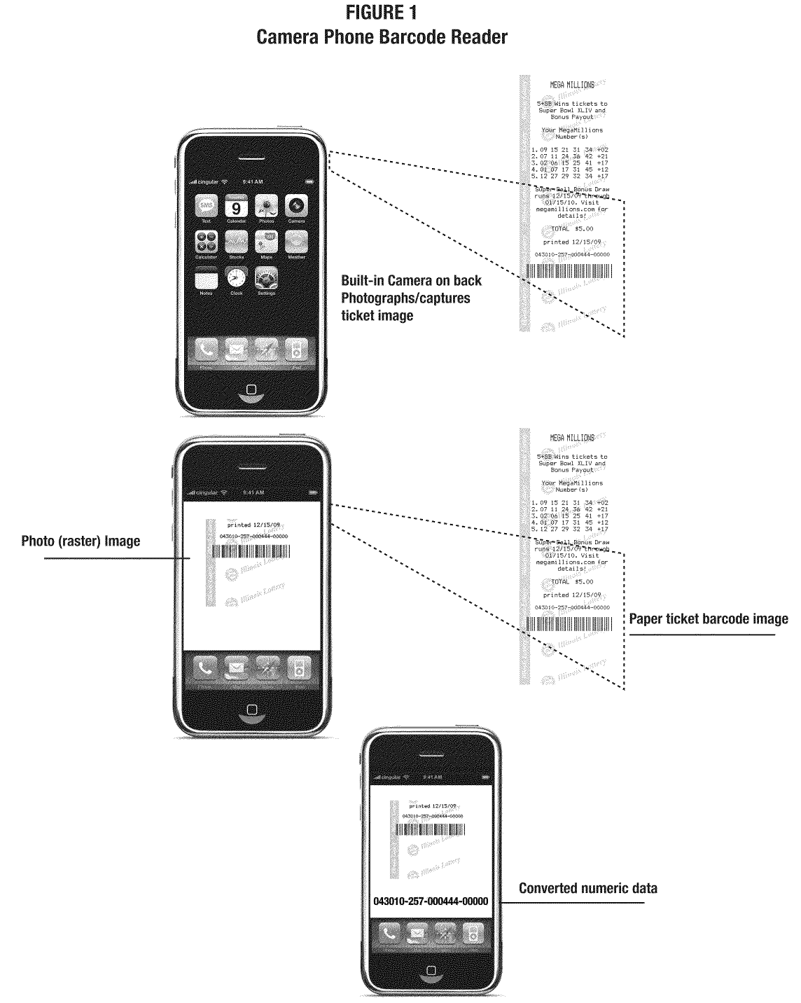

FIG. 2—DB Query Process: Once the unique ticket code is identified, it can be used as a parameter in an SQL script that can be sent over the phone data connection to query a database server of purchased lottery tickets. The query pulls the data from that ticket, then cross references it with the winning data from a drawing. The database can then create a resultset of data to return back to the mobile device. The software application on the phone intercepts the resultset and assembles it on the mobile device to show the user if that ticket is a winner.

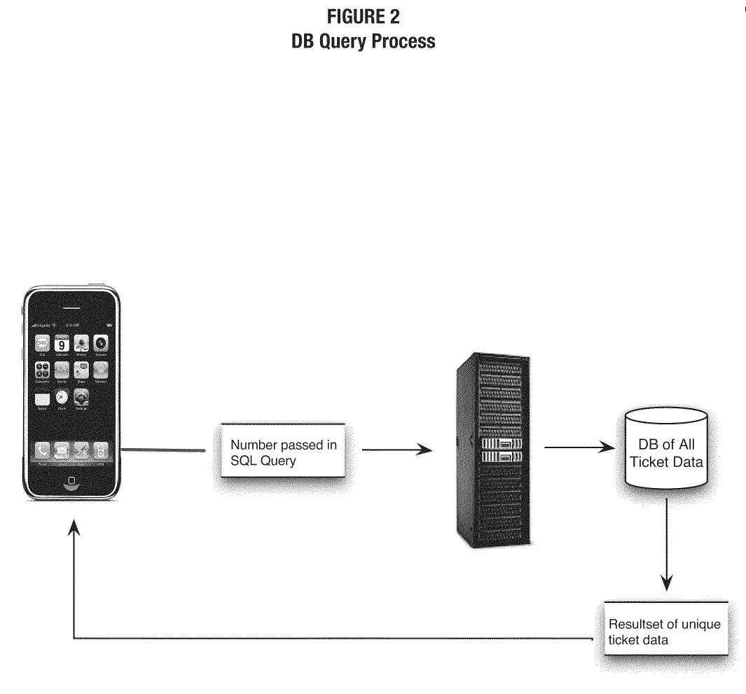

FIG. 3—Screen Shot Result: This is the PDA window that displays the result from the scan.

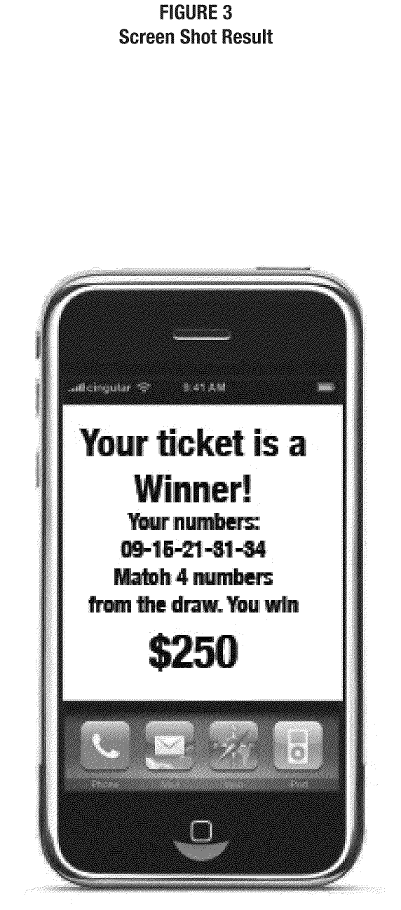

### DETAILED DESCRIPTION OF THE INVENTION

Millions of dollars in unclaimed prizes are accumulated by lotteries across the country. Some prizes are unclaimed because of lost or damaged tickets, but the majority of unclaimed prizes come from lack of player awareness. They don't realize that in jackpot draw games, you can win prizes for matching 5 of 6, 4 of 6 or even 3 of 6 numbers in a draw. Some players are unaware that they are holding a winning ticket and discard.

A player can take any lottery ticket back to a lottery retailer and have it scanned to see if it is a winner. That process is inconvenient, as the player has to return to the retailer, sometimes wait in line and possibly risk losing their ticket to a dishonest clerk.

As an alternative, the player can download the Mobile CAT application to his iPhone®, Blackberry® or other camera phone with mobile network data service.

The Mobile CAT application can be programmed for multiple device formats. The iPhone®, Blackberry® and Motorola® phones each have their own development platforms for mobile applications. A number of different mobile devices support J2ME (Java Mobile edition) and Mobile CAT will have a version for those devices.

Mobile CAT uses an open source application called ZXing (Zebra Crossing) licensed under the Apache License v2.0. This patent does not try to claim any rights to that method or to the good work accomplished by those developers. It is a module in the application used to capture and convert barcode image via the built-in camera of the device.

Once converted, the string number is encrypted and then embedded as a parameter in a SQL string, designed to query specific information about that purchased ticket. Each terminal generated ticket is assigned with specific information designed to determine the outcome of a lottery drawing. This information includes: location of purchase, retailer id number, date/time of purchase, numbers selected for ticket, dollar amount paid for ticket, drawing date for the ticket, game type (Powerball, Mega Millions, Pick 6, etc). This data is housed in a central database either at the lottery offices or with the contracted lottery ticket vendor.

The Mobile CAT is not designed to validate tickets. Validation must still occur through the closed network terminals at the lottery and lottery retail locations. The results of the Mobile CAT are not 100% guaranteed accurate. They are designed as an alternative method of determining win/loss outcome. Currently players can determine win/loss by a) watching the drawing live, b) checking the newspaper the following day, c) visiting the lottery website to pull up a historical list of winning numbers or d) visiting the retailer to check against the system.

Even though it is READ ONLY access, for security reasons, a lottery may not allow the SQL script query to be sent directly to the lottery server that stores the ticket information. In those instances, the lottery vendor could supply a daily export of limited ticket information into a 3^{rd} party secure database server. While having access to all the ticket information, it is reasonable to understand that the database could be compromised and if someone had all the generated ticket information, they could search for winning combinations and try to counterfeit a winning ticket.

Understanding that, the Mobile CAT process would limit access to certain fields and protect the transmission of the winning codes. The ticket holder and the lottery database are the only locations of a specific ticket serial (barcode) number. That serial number is the key for securing and validating a winning ticket. By encrypting that number before embedding into the SQL string query, any intercepted communications will be secure. The exported data from the lottery winning ticket server can be a matching encrypted number, rather than the actual serial number. This method would still allow for the query to pull the proper data, WITHOUT compromising the security of winning ticket data. In the event that someone gains access to the database, they could not counterfeit a ticket without the unique serial number. There are several methods of encryption that can be employed and Mobile CAT will employ the highest levels to ensure security of the process.

There are several methods of distribution for the Mobile CAT application. For the iPhone®, the application would be available for download from the Apple App Store. Each service provider for mobile data networking has a similar application store/site that connects directly through the device. Depending on the desires of the lottery, this application could be distributed in that method or we can provide a dedicated download site. The player would use their camera enabled mobile device to download the application from the specific location.

Once installed on the device, the player can run the application. The application would immediately determine if the device has the proper hardware installed. It will detect for a built-in camera and an open data connection. If either of these elements are missing, an error code will generate alerting the user that it is unable to function.

Once all hardware features are detected and functioning, the player is prompted by the application to capture a ticket. The built-in camera is enabled and a viewer window appears in the screen. The user is instructed to align the ticket barcode in a cross hair/target bracket within the viewer. This ensures an aligned clear image. The player is then prompted by the software to keep as steady a hand as possible and push the button to take the picture.

If the captured image is illegible or unreadable by the ZXing application, a response message will appear asking the user to retake the photo. The viewer window will return and the user can realign the image to take the photo again. If the captured picture is readable, the software will immediately convert the image to numeric code.

Once the ticket serial number is generated, the software converts that number to an encrypted string. That encrypted string is embedded as a parameter in a SQL script. Once the script is prepared and ready to send, the software attempts a connection to the remote server where the lottery winning information is stored. If the mobile device cannot make a connection, an error message generates telling the user that a connection is not available at this time. The user does not have to start over if this happens; the SQL script is stored in their device until it is able to make a connection. Mobile CAT can be set to automatically attempt on a schedule (every 2 minutes) or it can be set to manual attempts prompting the user to click a ‘check again’ button.

Once a connection is made to the remote server, the query is sent and the software waits for a response. If the encrypted serial number does not match a number in the database, an error is returned telling the user “Sorry, your ticket does not match a live ticket in the database. Please check your ticket at an authorized Lottery retailer.” If the ticket correctly matches an encrypted number, it returns the information within that database record.

The information in the ticket database uses the drawing date field of the ticket record to reference a table of winning numbers, also in the database. If the database determines that the drawing date assigned to the ticket has “not yet occurred”, that message will appear on the device inviting the player to check again after that date/time. Again, the player doesn't have to rescan the ticket, the data will be stored until the drawing occurs and the query returns a win/loss result.

Once a win/loss result set is determined, the Mobile CAT application compiles that information into a graphically appealing display to alert the user. The results will appear in a replication of the physical ticket, highlighted against the winning numbers. If the result is any of the possible winning combinations for that game (eg Powerball—6 of 6, 5 of 6, 4 of 6, 3 of 6) a banner will appear that reads “WIN”. It will highlight the numbers that match and indicate the winning amount for that combination. And depending on the device, a ‘winner’ sound file will generate. The application could be built to have different choices of audio files for “Winning” chime and “Non-Winning” chime. If there are multiple plays on a ticket, the application will highlight all the winning combinations for that ticket and calculate the individual prize amounts, then sum the total for the ticket.

A disclaimer will appear at the bottom of the display stating that “This win information has been determined based on the information provided and does NOT validate your possession of an actual winning ticket. You must still present the physical winning ticket to an authorized lottery retailer for validation and claim of your prize.”

Users of the application can pre-scan and store their ticket information prior to a drawing date. With the automation feature set, the application will send the query after the drawing date and automatically alert the user of the results once verified. Using the Win/Loss chime audio setting, the device will sound based on outcome.

What is claimed is:

1) A process by which a lottery ticket can be evaluated as a winning or non-winning ticket using popular consumer mobile communication devices and a proprietary mobile software application

2) The method by which claim 1 uses the built-in camera on the mobile device to convert the lottery barcode ticket to a numeric data format

3) The method by which the converted numeric data in claim 2 is encrypted for secure transfer to a remote server database populated with ticket information

4) The method by which the encrypted data in claim 2 is matched against a read-only database on a remote server to generate specific result data for that ticket

5) The method by which the result data of claim 4 is compiled and returned to the user's mobile device

6) The method of managing the communication between the device and the information database server to automate a send/receive or allow manual send/receive.

7) The method by which claim 6 is able to manage results of lottery tickets for which a drawing has not yet occurred, by scheduling calls to the database using the drawing date data.

8) The method of alerting the user of received/compiled data with audio and graphic notification, upon receipt from an automated or manual call to the database.

9) The method of throwing errors if the software determines conflicts in communicating with the hardware, communicating with the database or an inability to produce a valid result.

10) The method by which the user can register ownership of his/her ticket by sending a response back to the ticket server database from the mobile device.

11) The method by which claim 10 captures and transmits the user id information by either stored information on the mobile device or referencing another remote database with stored registration information.
